(19) United States
(12) Patent Application Publication
(10) Pub. No.: US 2003/0142133 A1
(43) Pub. Date: Jul. 31, 2003

(54) Adjusting transparency of windows to reflect recent use

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: Marilyn Smith Dawkins, International Business Machines Corporation, Intellectula Property Law Dept., Internal Zip 4054, 11400 Burnet Road, Austin, TX, 78758, US

(73) Assignee: International Business Machines Corporation, Armonk, NY

(21) Appl. No.: 10/058,532

(22) Filed: Jan. 28, 2002

(51) Int. Cl. G09G 5/00

(52) U.S. Cl. 345/768; 345/790; 345/803

(57) ABSTRACT

A method, system, and program for adjusting the transparency of windows to reflect recent use are provided. Current use of multiple displayable objects is detected. A transparency associated with each of the displayable objects is automatically selectively adjusted to reflect the current use of each of the displayable objects, such that recent use of the displayable objects is graphically represented independent of the z-order of the displayable objects.

### CROSS-REFERENCE TO RELATED APPLICATIONS

The present application is related to the following co-pending applications, which are filed on even date herewith and incorporated herein by reference:

(1) U.S. patent application Ser. No. ______/______ (Attorney Docket No. AUS920010513US1); and

(2) U.S. patent application Ser. No. ______/______ (Attorney Docket No. AUS920010514US1);

(3) U.S. patent application Ser. No. ______/______ (Attorney Docket No. AUS920010515US1);

(4) U.S. patent application Ser. No. ______/______ (Attorney Docket No. AUS920010516US1);

(5) U.S. patent application Ser. No. ______/______ (Attorney Docket No. AUS920010517US1);

(6) U.S. patent application Ser. No. ______/______ (Attorney Docket No. AUS920010519US1);

(7) U.S. patent application Ser. No. ______/______ (Attorney Docket No. AUS920010520US1);

(8) U.S. patent application Ser. No. ______/______ (Attorney Docket No. AUS920010521US1);

(9) U.S. patent application Ser. No. ______/______ (Attorney Docket No. AUS920010522US1);

(10) U.S. patent application Ser. No. ______/______ (Attorney Docket No. AUS920010524US1); and

(11) U.S. patent application Ser. No. ______/______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to adjusting a transparency of windows to reflect recent use.

2. Description of the Related Art

Most operating systems provide a graphical user interface (GUI) for controlling a visual computer environment. The GUI represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical object defined by a GUI is a window or other defined area of a display containing distinguishable text, graphics, video, audio and other information for output. A display area may contain multiple windows associated with a single software program or multiple software programs executing concurrently.

Often when multiple graphical objects are displayed concurrently, the graphical objects will overlap. The order in which graphical objects are drawn on top of one another onscreen to simulate depth is typically known as the z-order. Typically, those objects at the top of the z-axis obscure the view of those graphical objects drawn below.

In some operating systems, a level of transparency or translucency may be applied to graphical objects, and in particular to windows. By applying a level of translucency to upper level windows, lower level windows are visible therethrough. Utilizing translucency is particularly advantageous such that the title bars for multiple levels of windows are visible where the windows overlap.

While adjusting the transparency of a top window is advantageous, it would be more advantageous if the adjustment of transparency of windows reflected the status of windows.

In view of the foregoing, it would be advantageous to provide a method, system, and program for adjusting a transparency of windows according to recent use of a window. Moreover, it would be advantageous to adjust a transparency of windows to reflect recent use of windows according to a user's recent use preferences. Further, it would be advantageous to adjust a transparency of windows to reflect the recent use of windows independent of the current z-order of the windows.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for adjusting a transparency of windows to reflect recent use.

According to one aspect of the present invention, current use of multiple displayable objects is detected. Both active use and idleness of displayable objects is detected. A transparency associated with each of the displayable objects is automatically selectively adjusted to reflect the current use of each of the displayable objects, such that recent use of the displayable objects is graphically represented independent of the z-order of the displayable objects. Where the transparency associated with a graphical object reaches a particular threshold, the graphical object may be minimized.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a graphical representation of a user interface where transparencies of windows are adjusted according to recent usage in accordance with the method, system, and program of the present invention;

FIG. 3 depicts a graphical representation of a window a graphical representation of a user interface in which the transparencies of windows adjust according to recent use in accordance with the method, system, and program of the present invention;

FIG. 4 illustrates a graphical representation of a user interface in which the least recently used window is minimized in accordance with the method, system, and program of the present invention;

FIG. 5 depicts a block diagram of recently used preferences for a particular user in accordance with the method, system, and program of the present invention; and

FIG. 6 illustrates a high level logic flowchart of a process and program for adjusting windows according to recent use in accordance with the method, system, and program of the present invention.

### DETAILED DESCRIPTION OF THE PREFERRED EMBODIMENT

A method, system, and program for adjusting the transparency of windows according to recent application use are provided. In addition to windows, the transparency of other displayable objects may be adjusted without effecting the z-order of those displayable objects. A “displayable object” may include text, icons, video, graphics, windows, or other graphical representations displayable within a display area. Displayable objects may be hidden or visible. Further, displayable objects may be layered in a z-order. Moreover, a displayable object may utilize a portion of a display area or may extend across the entirety of a display area. A displayable object may or may not include definable boundaries.

A z-order is the order along the z-axis in which displayable objects appear. Through a z-buffering technique, a depth is associated with each displayable object such that each object appears to be set at a particular depth in comparison with other displayable objects. There may be n-levels of layers within the z-order, where multiple displayable objects may be positioned within a particular n-level of the z-order.

The z-order may be a result of the order in which a user opens displayable objects onto the display. Alternatively, according to one advantage of the present invention, a user may designate for the z-order to be set according to a particular criteria.

Transparency is a graphical feature that is particularly advantageous to the present invention when displaying multiple displayable objects within a user interface where those displayable objects may overlap. As will be understood by one skilled in the art, by making a displayable object appear transparent on a computer screen, other displayable objects positioned below the transparent displayable object are rendered visible through the transparent displayable object. Further, the transparency of a displayable object may be adjusted from opaque to totally transparent.

Typically, the transparency attribute is stored with color values in an alpha channel. Then, when calculating the appearance of a given pixel, the graphic processor uses the alpha channel values to determine the pixel's color through a process termed alpha blending. Through alpha blending, the process adds a fraction of the color of the transparent object set by the alpha channel value to the color of the displayable object below. Mixing the colors together gives the appearance that the displayable object below is seen through a layer of the transparent displayable object. In addition to alpha blending, additional shading may be added to create shadows and other graphical images to cue the viewer to the position of the transparent displayable object.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computer system is a portable computing system such as a notebook computer, a palmtop computer, a personal digital assistant, a telephone or other electronic computing system that may also incorporate communications features that provide for telephony, enhanced telephony, messaging and information services. However, the computer system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

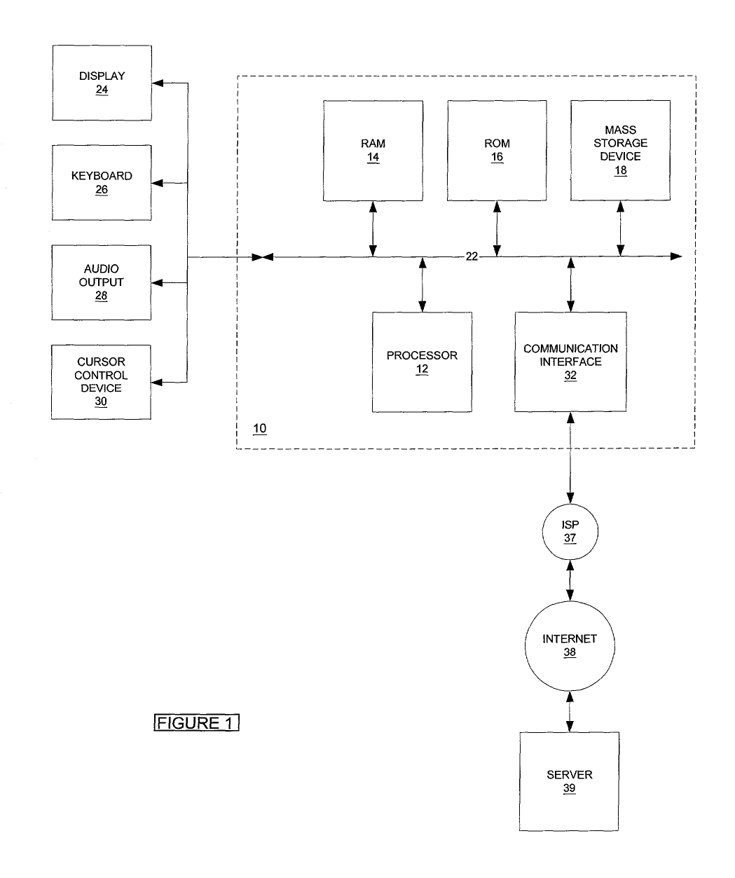

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

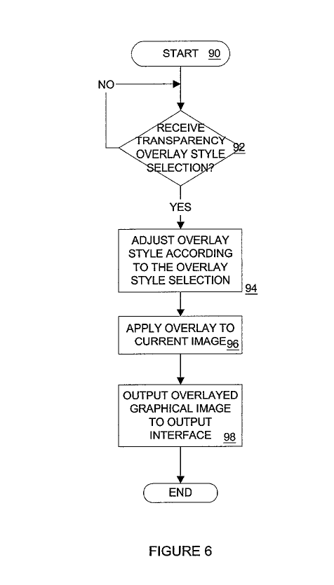

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIG. 6 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. Keyboard 26 and cursor control device 30 can control the position of a cursor positioned within a display area of display 24. It should be understood that keyboard 26 and cursor control device 30 are examples of multiple types of input devices that may be utilized in the present invention. In alternate embodiments of the present invention, additional input and output peripheral components may be added.

### Recently Used Translucency Context

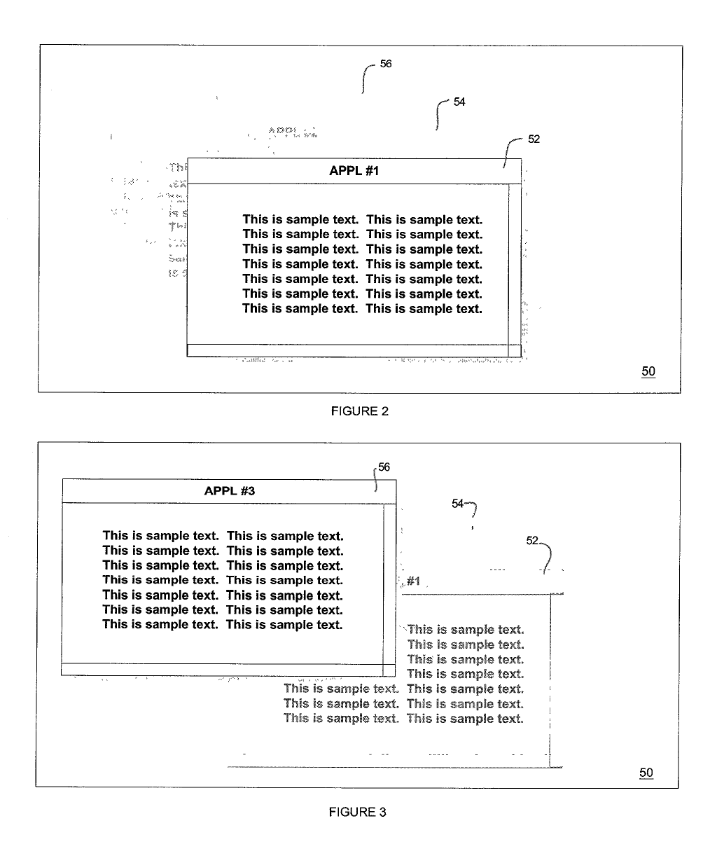

Referring now to FIG. 2, there is depicted a graphical representation of a user interface where transparencies of windows are adjusted according to recent usage in accordance with the method, system, and program of the present invention. As illustrated, a user interface 50 includes windows 52, 54, and 56. In the present example, window 52 is positioned at the top level of the z-order, followed in position by window 54, and then window 56. As depicted, each of windows 52, 54, and 56 are set at a particular level of transparency. In the present example, window 52 is set at 0% transparency, while window 54 is set at 20% transparency and window 52 set at 50% transparency.

Usage of each window may reflect the usage of an application represented by each window. Where multiple windows are open within a single application, windows may be ordered according to recent use within the single application.

In the present example, window 52 is the most recently used, window 54 is the next most recently used, and window 56 is the least recently used. In alternate examples, windows may be ordered where the least recently used application window is at the top.

With reference now to FIG. 3, there is illustrated a graphical representation of a user interface in which the transparencies of windows adjust according to recent use in accordance with the method, system, and program of the present invention. As depicted, the transparency of windows 52, 54 and 56 is adjusted to reflect the recent use of the windows.

According to one advantage of the present invention, each window is set at a transparency to reflect recent use in comparison with other windows. For example, the most recently utilized window is set at the least transparency and the least recently utilized window is set at the greatest transparency. In the present example, window 56 is the most recently used and therefore is set to 0% transparency. Window 52 is the next most recently used, and therefore set to a greater transparency than window 56. Then, window 54 is the least recently used, and therefore set to a greater transparency than window 52.

According to another advantage of the present invention, each window is set at a transparency to reflect individual recent use . For example, window 56 is set at 0% transparency to reflect recent use. However, as window 56 remains idle, the transparency of window 56 will increase. Further, in the example, window 54 has adjusted from 50% transparency in FIG. 2, to 70% transparency in FIG. 3, to reflect the individual recent use of window 54.

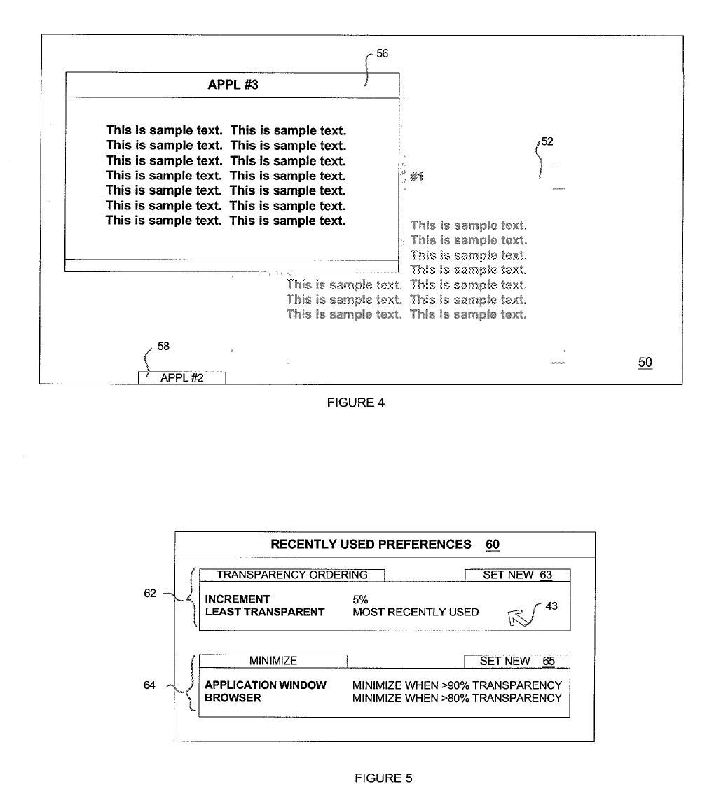

Referring now to FIG. 4, there is depicted a graphical representation of a user interface in which the least recently used window is minimized in accordance with the method, system, and program of the present invention.

According to one advantage of the present invention, as windows remain idle, the transparency of the window only adjusts until the transparency value reaches a particular threshold. After the transparency values reaches the particular threshold, the window is preferably reduced into an icon or other displayable object. In the present example, an icon 58 represents a reduced window. In particular, icon 58 represents window 54, after window 54 has remained idle and the transparency value of window 54 has increased above a particular threshold.

With reference now to FIG. 5, there is illustrated a block diagram of recently used preferences for a particular user in accordance with the method, system, and program of the present invention. As depicted, recently used preferences 60 include transparency ordering preferences 62 and minimizing preferences 64.

In the example, transparency ordering 62 is designated according to an percentage increment for increasing transparency and a time increment for increasing transparency. For example, the transparency of windows remaining idle will increase by 5% every ten minutes. Advantageously, a user may adjust the transparency ordering settings by selecting selectable button 63 with cursor 43 or other selection input.

In addition, in the example, transparency ordering 62 is designated according to the type of window that will be least transparent. In the example, the most recently used window is the least transparent. However, the least transparent may also be set as the least recently used window.

Minimizing preferences 64 may be distinguished according to the type of application window. In the example, a transparency may be designated for application windows and browser windows. Advantageously, a user may adjust the minimizing preferences by selecting selectable button 65 with cursor 43 or selection input.

Referring now to FIG. 6, there is depicted a high level logic flowchart of a process and program for adjusting windows according to recent use in accordance with the method, system, and program of the present invention. As illustrated, the process started at block 70, and thereafter proceeds to block 72.

Block 72 depicts a determination as to whether or not there is an adjustment in recent window usage. Preferably, both changes in window usage and idleness are considered adjustments to recent window usage. In addition, preferably usage of reduced applications is preferably monitored. If there is not an adjustment in recent window usage, then the process iterates at block 72. If there is an adjustment in recent window usage, then the process passes to block 74.

Block 74 illustrates determining the current ordering of windows. Preferably the window ordering includes windows that are open and windows that have been minimized. Next, block 76 depicts adjusting the transparency level of each displayable object according to the current order and transparency increment preferences of the user; and the process passes to block 78.

Block 78 depicts a determination as to whether or not any of the displayable objects currently meet minimizing preferences. If none of the displayable objects meet minimizing preferences, then the process passes to block 82. If displayable objects meet minimizing preferences, then the process passes to block 80. Block 80 illustrates automatically minimizing any displayable objects meeting minimizing preferences; and the process ends.

Block 82 illustrates a determination as to whether or not any of the minimized displayable object transparencies have increased above the minimization threshold. If no minimized displayable object transparencies have increased above the minimization threshold, then the process ends. If at least one minimized displayable object transparencies has increased above the minimization threshold, then the process passes to block 84. Block 84 depicts automatically opening the qualifying minimized displayable objects with the transparencies applied thereto, and the process ends. In particular, the user transparency preferences may also be applied when opening the qualifying minimized displayable objects.

While the invention has been particularly shown and described with reference to a preferred embodiment, it will be understood by those skilled in the art that various changes in form and detail may be made therein without departing from the spirit and scope of the invention.

What is claimed is:

1. A method for adjusting displayable objects according to recent use, said method comprising the steps of:
detecting current use of a plurality of displayable objects; and
automatically selectively adjusting a transparency associated with at least one of said plurality of displayable objects to reflect said current use of said at least one of said plurality of displayable objects, such that recent use of said at least one of said plurality of displayable objects is graphically represented.

2. The method for adjusting displayable objects according to claim 1, said step of detecting current use of a plurality of displayable objects further comprising the step of:
detecting idleness of said plurality of displayable objects.

3. The method for adjusting displayable objects according to claim 1, said step of detecting current use of a plurality of displayable objects further comprising the step of:
detecting active use of said plurality of displayable objects.

4. The method for adjusting displayable objects according to claim 1, said step of automatically selectively adjusting a transparency associated with said at least one of said plurality of displayable objects further comprising the step of:
adjusting said transparency associated with said at least one of said plurality of displayable objects according to user recently used preferences.

5. The method for adjusting displayable objects according to claim 1, said method further comprising the step of:
minimizing said at least one of said plurality of displayable objects, in response to a value of said transparency associated with said at least one of said plurality of displayable objects reaching a particular threshold.

6. The method for adjusting displayable objects according to claim 1, said step of automatically selectively adjusting a transparency associated with at least one of said plurality of displayable objects further comprising the step of:
adjusting said transparency associated with said at least one of said plurality of displayable objects, wherein said transparency adjusts according to a comparison of use of said at least one of said plurality of displayable objects.

7. A system for adjusting displayable objects according to recent use, said system comprising:
a graphical user interface;
means for detecting current use of a plurality of displayable objects displayed within said graphical user interface; and
means for automatically selectively adjusting a transparency associated with at least one of said plurality of displayable objects to reflect said current use of said at least one of said plurality of displayable objects.

8. The system for adjusting displayable objects according to claim 7, said means for detecting current use of a plurality of displayable objects further comprising:
means for detecting idleness of said plurality of displayable objects.

9. The system for adjusting displayable objects according to claim 7, said means for detecting current use of a plurality of displayable objects further comprising:
means for detecting active use of said plurality of displayable objects.

10. The system for adjusting displayable objects according to claim 7, said means for automatically selectively adjusting a transparency associated with said at least one of said plurality of displayable objects further comprising:
means for adjusting said transparency associated with said at least one of said plurality of displayable objects according to user recently used preferences.

11. The system for adjusting displayable objects according to claim 7, said system further comprising:
means for minimizing said at least one of said plurality of displayable objects, in response to a value of said transparency associated with said at least one of said plurality of displayable objects reaching a particular threshold.

12. The system for adjusting displayable objects according to claim 7, said means for automatically selectively adjusting a transparency associated with at least one of said plurality of displayable objects further comprising:
means for adjusting said transparency associated with said at least one of said plurality of displayable objects, wherein said transparency adjusts according to a comparison of use of said at least one of said plurality of displayable objects.

13. A program for adjusting displayable objects according to recent use, residing on a computer usable medium having computer readable program code means, said program comprising:
means for detecting current use of a plurality of displayable objects; and
means for controlling selective adjustment of a transparency associated with at least one of said plurality of displayable objects to reflect said current use of said at least one of said plurality of displayable objects.

14. The program for adjusting displayable objects according to claim 13, said program further comprising:
means for detecting idleness of said plurality of displayable objects.

15. The program for adjusting displayable objects according to claim 13, said program further comprising:
means for detecting active use of said plurality of displayable objects.

16. The program for adjusting displayable objects according to claim 13, said program further comprising:
means for controlling adjustment of said transparency associated with said at least one of said plurality of displayable objects according to user recently used preferences.

17. The program for adjusting displayable objects according to claim 13, said program further comprising:
means for controlling minimization of said at least one of said plurality of displayable objects, in response to a value of said transparency associated with said at least one of said plurality of displayable objects reaching a particular threshold.

18. The program for adjusting displayable objects according to claim 13, said program further comprising:
means for controlling adjustment of said transparency associated with said at least one of said plurality of displayable objects, wherein said transparency adjusts according to a comparison of use of said at least one of said plurality of displayable objects.
